(19) United States
(12) Patent Application Publication
(10) Pub. No.: US 2011/0253489 A1
(43) Pub. Date: Oct. 20, 2011

(54) Apparatus and a System for Mitigating Wheel Skidding In a Manual Brake System

(76) Inventor: Gregory A. Ward, Pasadena, CA (US)

(21) Appl. No.: 12/841,473

(22) Filed: Jul. 22, 2010

Related U.S. Application Data
(60) Provisional application No. 61/325,237, filed on Apr. 16, 2010.

(51) Int. Cl. B60T 8/176; F16D 65/30; F16D 65/34; B60T 8/36

(52) U.S. Cl. 188/156; 303/119.1

(57) ABSTRACT

An apparatus and a system include an actuator assembly configured for controlling a movement of a manual mechanical linkage shaft in a manual brake system for a vehicle wheel. An electric motor drives the actuator assembly wherein a manually applied force to the manual mechanical linkage shaft is modulated or pulsed. A lock and release assembly is configured for engaging and disengaging the actuator assembly to and from the manual mechanical linkage shaft. Means actuates the lock and release assembly to engage the actuator assembly to the manual mechanical linkage shaft, and disengage the actuator assembly from the manual mechanical linkage shaft. An electronic controller controls the electric motor during a braking of the vehicle wheel to mitigate skidding of the vehicle wheel during the braking

### CROSS-REFERENCE TO RELATED APPLICATIONS

The present Utility patent application claims priority benefit of the U.S. provisional application for patent Ser. No. 61/325,237 and entitled “Antiskid System For General Aviation Aircraft”, filed on 16 Apr. 2010 under 35 U.S.C. 119(e). The contents of this related provisional application are incorporated herein by reference for all purposes.]

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to brake systems for general aviation aircraft. More particularly, the invention relates to a low cost, antiskid brake system.

### BACKGROUND OF THE INVENTION

Electronic controlled antiskid systems are found on many wheeled vehicles including most cars, large airplanes and some motorcycles. These vehicles have powered hydraulic or pneumatic brake systems that work in conjunction with the antiskid system. These electronic controlled antiskid systems use wheels speed sensors, an electronic controller and control valves to regulate the brake pressure in the powered brake systems to reduce tire skids. These electronic controlled antiskid systems increase safety by improving directional control and shortening the stopping distance of the vehicle by reducing tire skids when braking These electronic controlled antiskid systems are also referred to as Antilock Brake Systems (ABS).

Manual brake systems use the force from an operator's feet and/or hands to provide the energy to actuate and power hydraulic or mechanical brakes. These vehicles do not have powered hydraulic or pneumatic brakes. Examples of wheeled vehicles with manual brakes include general aviation aircraft, motorcycles, and bicycles. Although there are a large number of vehicles with manual brakes that would benefit from an electronic controlled antiskid system, to date there are few if any practical electronic controlled antiskid systems available for these vehicles. It is therefore an objective of the present invention to provide an antiskid brake system that is practical for use on these types of vehicles.

Almost all electronic controlled antiskid systems in use today on wheeled vehicles require a powered hydraulic or pneumatic brake system for their operation. Power for these brake systems is generally provided from a hydraulic or pneumatic pump coupled to the vehicle's engine or an electric motor that gets its power from the vehicle's electrical system.

FIG. 1 is a schematic diagram showing a powered hydraulic brake system with an electronic controlled antiskid system for an aircraft with two main wheels 115, in accordance with the prior art. Hydraulic fluid is directed from a reservoir 100 to a hydraulic pump 102 via a hydraulic pipe 101. Pump 102 is driven by a vehicle engine 103 or an electric motor 104 that is powered by the vehicle's electrical system. Hydraulic fluid is directed from pump 102 through a hydraulic pipe 105 to a relief valve 106 that ensures that the maximum hydraulic system pressure is not exceeded. The hydraulic fluid is directed to left and right metering valves 108 through hydraulic pipes 107.

An aircraft brake system allows the pilot to apply the brakes independently to left and right main wheels 115 by pressing on left and right brake pedals 109. Left and right brake pedals 109 are connected to their respective metering valves 108. When the pilot pushes on brake pedals 109, metering valves 108 modulate the pressure of the hydraulic fluid through pipes 110 to brake cylinders 111. Brake pistons 112 inside brake cylinders 111 are connected to brake pads 113. When the pilot pushes on brake pedals 109, brake cylinders 111 cause brake pads 113 to push against brake discs/drums 114 creating the friction to slow the turning brake discs/drums 114 that are connected to wheels 115. This action slows or stops the aircraft. A back up system is required for some vehicles so they can be stopped if there is a loss of power to the brake system. On a powered hydraulic brake system, this can be accomplished by adding a hydraulic accumulator 124 to the brake system.

The electronic controlled antiskid system needs to monitor the rotation of wheels 115 to determine when a skid is occurring or about to occur. This is done with wheel speed sensors 116 located at each wheel 115. A tone ring 117 turns with wheel 115 and creates a magnetic field disruption that can be detected by wheel speed sensors 116. Wheel speed sensor 116 and tone ring 117 are typically integrated into a single unit and located inside the axle on large aircraft. The wheel speed signals are sent to an electronic controller 119 using electrical cables 118. Using the speeds from wheel speed sensors 116, electronic controller 119 determines when a skid condition is occurring and sends a signal to required control valves 122 through electrical cables 120 to reduce the brake pressure. Hydraulic fluid is released from brake cylinders 111 through pipes 121, through control valves 122 and through pipes 123 back to reservoir 100. When controller 119 determines that the skid event is over, it commands required control valves 122 to close, and the brake system returns to its normal braking mode.

FIGS. 2A and 2B illustrate manual brake systems, according to the prior art. FIG. 2A is a schematic diagram showing a manual hydraulic brake system for a general aviation aircraft, and FIG. 2B is a schematic diagram showing a manual mechanical brake system for a motorcycle or bicycle. Manual brake systems use the force from the operator's feet and/or hands to provide the energy to actuate and power the hydraulic or mechanical brakes. Manual hydraulic brake systems are common on general aviation aircraft, motorcycles, and bicycles. These vehicles do not have powered hydraulic or pneumatic brakes. These vehicles use a separate hand or foot lever for each wheel that has a brake.

Referring to FIG. 2A, a manual hydraulic brake system for a right main wheel 115 is shown for a general aviation (GA) aircraft. There is also a duplicate manual hydraulic brake system for the left main wheel on the GA aircraft. The pilot provides the power for the actuation of the brakes by pushing on a brake pedal 200 with his foot. Brake pedal 200 is coupled to an input shaft 201 that is inserted into a hydraulic master cylinder 202. Input shaft 201 is connected to a master cylinder piston 203 located inside master cylinder 202. When the pilot pushes on brake pedal 200, hydraulic fluid is moved out of master cylinder 202 and into a brake pipe 204 that is connected to a brake cylinder 111. Fluid in brake pipe 204 is pushed into brake cylinder 111 thus moving a brake piston 112. Brake piston 112 is connected to a brake pad 113, which is pushed against a brake disc/drum 114 creating the friction to slow the turning brake disc/drum 114 that is connected to wheel 115. This action slows or stops the aircraft.

Manual mechanical brake systems are common on motorcycles and bicycles. These vehicles use a separate hand and/or foot lever for the front and rear wheels, which each have a brake. Referring to FIG. 2B, a manual mechanical brake system for a motorcycle or bicycle is shown. Only the brake system for the rear wheel is shown. There is normally a manual mechanical brake system for the front wheel as well on motorcycles and bicycles. The vehicle operator provides the power for the actuation of the brakes by pushing or pulling on a brake lever 200 with his hand and/or foot. Brake lever 200 is coupled to a mechanical lever 206 with a rod or cable 205. When the operator pushes or pulls on brake lever 200, mechanical lever 206 pulls or pushes on a rod or cable 207 that is connected to a mechanical lever 208 that is connected to a brake pad 113, which is pushed against a brake disc/drum 114 creating the friction to slow the turning brake disc/drum 114 that is connected to a wheel 115. This action slows or stops the vehicle. The number and arrangement of rods, cables and levers in different manual mechanical brake systems varies depending on the geometry of the vehicle.

Hybrid manual brake systems exist that combine hydraulic and mechanical linkages to couple the operator's hand and/or foot movements to operate and power the brake mechanism. The brake pads in these hybrid manual brake systems can be mechanically or hydraulically actuated.

There are currently known electronically controlled antiskid systems for manual hydraulic brake systems for motorcycles, however, there are no electronically controlled antiskid systems for manual mechanical brakes like those used on motorcycles and bicycles. As illustrated by way of example in FIG. 1, today's electronically controlled antiskid systems are not well suited for vehicles with manual brakes since a power source for the brake system must be added to the vehicle. This is typically not practical due to the added weight, cost and the difficulty of mounting the many needed components. This is the reason there are so few electronically controlled antiskid systems today for wheeled vehicles with manual brakes. There are several currently known mechanical antiskid devices, not systems, for bicycles with manual brakes. However, these mechanical devices offer reduced antiskid performance when compared to electronically controlled antiskid devices.

In view of the foregoing, there is a need for improved techniques for providing a low cost, electronically controlled antiskid system that may be implemented in a practical manner on manual brakes.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram showing a powered hydraulic brake system with an electronic controlled antiskid system for an aircraft with two main wheels, in accordance with the prior art;

FIGS. 2A and 2B illustrate manual brake systems, according to the prior art. FIG. 2A is a schematic diagram showing a manual hydraulic brake system for a general aviation aircraft, and FIG. 2B is a schematic diagram showing a manual mechanical brake system for a motorcycle or bicycle;

FIGS. 3A, 3B and 3C are schematic diagrams showing an exemplary manual brake system for one wheel on a vehicle, in accordance with an embodiment of the present invention. FIG. 3A is an overall view of a simple hydraulic system with three alternate locations for a lock and release assembly and an actuator assembly, and FIG. 3B is a close-up view of a fourth alternate location for the lock and release assembly and the actuator assembly in the simple hydraulic system. FIG. 3C is an overall view of a more complex mechanical system with six alternate locations for the lock and release assembly and the actuator assembly;

FIGS. 4A and 4B are schematic diagrams illustrating an exemplary electronic controller for an antiskid system for manual brakes, in accordance with an embodiment of the present invention. FIG. 4A shows the electronic control as an On/Off switch, and FIG. 4B shows the electronic control with the addition of a rheostat;

FIG. 5 is a schematic diagram of an exemplary electronic controller in an electronically controlled antiskid system installed on two wheels of a vehicle, in accordance with an embodiment of the present invention;

FIGS. 6A through 6K illustrate eleven different exemplary methods to drive an actuator assembly, in accordance with embodiments of the present invention. FIG. 6A shows a piston. FIG. 6B shows a bellows actuator. FIG. 6C shows an inflatable accumulator. FIG. 6D shows a motor with a screw. FIG. 6E shows the motor with helical gears. FIG. 6F shows the motor with a worm gear. FIG. 6G shows the motor with a gear and a gear rack. FIG. 6H shows the motor with scissor arms. FIG. 6I shows the motor with a cam. FIG. 6J shows the motor with a lever arm. FIG. 6K shows an electric solenoid;

FIGS. 7A through 7J illustrate ten different exemplary methods of connecting a lock and release assembly to a brake linkage shaft, in accordance with embodiments of the present invention. FIG. 7A shows a locking tab method. FIG. 7B shows a locking clamp method. FIG. 7C shows a wire lock method. FIG. 7D shows a tapered wedge method. FIG. 7E shows a dual cam lock method. FIG. 7F shows a strap clamp method. FIG. 7G shows a locking collar method. FIG. 7H shows an external fork method. FIG. 7I shows an iron particle method, and FIG. 7J shows a hydraulic piston method;

FIG. 8 is a side view of an exemplary electric master cylinder (EMC) with an integrated actuator assembly, in accordance with an embodiment of the present invention; and

FIG. 9 is a side view of an exemplary wheel speed sensor attached to a brake caliper located on a main wheel, in accordance with an embodiment of the present invention.

Unless otherwise indicated illustrations in the figures are not necessarily drawn to scale.

### SUMMARY OF THE INVENTION

To achieve the forgoing and other aspects and in accordance with the purpose of the invention, an apparatus and a system for mitigating wheel skidding in a manual brake system is presented.

In one embodiment an apparatus includes means for controlling a movement of a manual mechanical linkage shaft in a manual brake system for a vehicle wheel, and means for directing the actuator assembly to control the movement of the manual mechanical linkage shaft during a braking of the vehicle wheel where the control of the movement mitigates skidding of the vehicle wheel during the braking Another embodiment further includes means for engaging and disengaging the controlling means to and from the manual mechanical linkage shaft. Yet another embodiment further includes means for driving the controlling means where a manually applied force to the manual mechanical linkage shaft is modulated to mitigate the skidding of the vehicle wheel during the braking Still another embodiment further includes means for actuating the engaging and disengaging means. Another embodiment further includes means for forming a unit suitable for replacing a manual hydraulic master cylinder of the manual brake system. Yet another embodiment further includes means for enabling the apparatus to be added to a hydraulic line of the manual brake system.

In another embodiment an apparatus includes an actuator assembly configured for controlling a movement of a manual mechanical linkage shaft in a manual brake system for a vehicle wheel. An electronic controller directs the actuator assembly to control the movement of the manual mechanical linkage shaft during a braking of the vehicle wheel where the control of the movement mitigates skidding of the vehicle wheel during the braking Another embodiment further includes a lock and release assembly configured for engaging and disengaging the actuator assembly to and from the manual mechanical linkage shaft. In yet another embodiment the apparatus is configured as an addition to the manual brake system. Still another embodiment further includes an electric servomotor for driving the actuator assembly where, under direction of the electronic controller, a manually applied force to the manual mechanical linkage shaft is modulated to mitigate the skidding of the vehicle wheel during the braking In another embodiment the actuator assembly includes a cam and cam followers disposed about the manual mechanical linkage shaft for moving the manual mechanical linkage shaft. In yet another embodiment the lock and release assembly includes a locking tab including a hole configured for engaging the actuator assembly to the manual mechanical linkage shaft. Still another embodiment further includes an electric solenoid for actuating the lock and release assembly to engage the actuator assembly to the manual mechanical linkage shaft, and a release spring for disengaging the actuator assembly from the manual mechanical linkage shaft. Another embodiment further includes a master cylinder joined to the actuator assembly, electric servomotor, lock and release assembly, and the electric solenoid for forming a unit suitable for replacing a manual hydraulic master cylinder of the manual brake system, thereby adding the apparatus to the manual brake system. In yet another embodiment the actuator assembly, electric servomotor, lock and release assembly, and the electric solenoid are centrally located about a linkage shaft joined to the master cylinder enabling the actuator assembly, electric servomotor, lock and release assembly, and the electric solenoid to be positioned in a plurality of positions for facilitating adding the apparatus to the manual brake system. Still another embodiment further includes a hydraulic cylinder having a mechanical linkage suitable for engaging the lock and release assembly and the actuator assembly for enabling the apparatus to be added to a hydraulic line of the manual brake system.

In another embodiment a system includes means for controlling a movement of a manual mechanical linkage shaft in a manual brake system for a vehicle wheel, means for driving the controlling means wherein a manually applied force to the manual mechanical linkage shaft is modulated or pulsed, means for engaging and disengaging the controlling means to and from the manual mechanical linkage shaft, means for actuating the engaging and disengaging means, and means for controlling the driving means during a braking of the vehicle wheel to mitigate skidding of the vehicle wheel during the braking Another embodiment further includes means for generating a signal including rotational information of the wheel. Yet another embodiment further includes means for automatically activating or deactivating the system in response to changes in force or pressure. Still another embodiment further includes means for powering the system. Another embodiment further includes means for engaging and disengaging the system, and for varying a frequency of the pulsed force.

In another embodiment a system includes an actuator assembly configured for controlling a movement of a manual mechanical linkage shaft in a manual brake system for a vehicle wheel. An electric motor drives the actuator assembly wherein a manually applied force to the manual mechanical linkage shaft is modulated or pulsed. A lock and release assembly is configured for engaging and disengaging the actuator assembly to and from the manual mechanical linkage shaft. Means actuates the lock and release assembly to engage the actuator assembly to the manual mechanical linkage shaft, and disengage the actuator assembly from the manual mechanical linkage shaft. An electronic controller controls the electric motor during a braking of the vehicle wheel to mitigate skidding of the vehicle wheel during the braking Another embodiment further includes a tone ring and a wheel speed sensor for generating a signal including rotational information of the wheel, the tone ring and the wheel speed sensor being configured for joining to an outside of the wheel's axel. In yet another embodiment the tone ring includes a gear shape on a circumference of a disc. In still another embodiment the electronic controller uses GPS information to determine ground speed of the vehicle. In another embodiment the electronic controller includes a portable computing device. In yet another embodiment the portable computing device provides a vehicle's operator with audio and/or visual signals during a skidding event. Still another embodiment further includes at least one switch for automatically activating or deactivating the system in response to changes in force or pressure. Another embodiment further includes a portable battery supply for powering the system. Yet another embodiment further includes an operator control for engaging and disengaging the system, and for varying a frequency of the pulsed force.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

At least some preferred embodiments of the present invention provide an electronically controlled antiskid system for wheeled vehicles with manual brakes to increase safety by improving directional control and shortening the stopping distance by reducing tire skids while braking when compared to conventional manual brake systems. At least some preferred embodiments are used with manual brake systems where the vehicle's operator uses their hands and/or feet to actuate and power the mechanical or hydraulic brakes. At least some preferred embodiments do not use any hydraulic or pneumatic power to apply the brakes. Instead, at least some preferred embodiments use an electronic controller and a wheel speed sensor to detect a tire skidding event on a wheeled vehicle and command an actuator to move the brake linkage to reduce the brake force that the operator is applying to the brake pads of the skidding wheel and thus reduce the tire skids. In at least some preferred embodiments, electrical power from the vehicles' electrical system is used to power the antiskid system, including the actuators. At least some preferred embodiments can operate on either DC or AC power. In addition, some embodiments can operate on portable battery power, which is ideal for bicycle applications that have no on-board electrical systems.

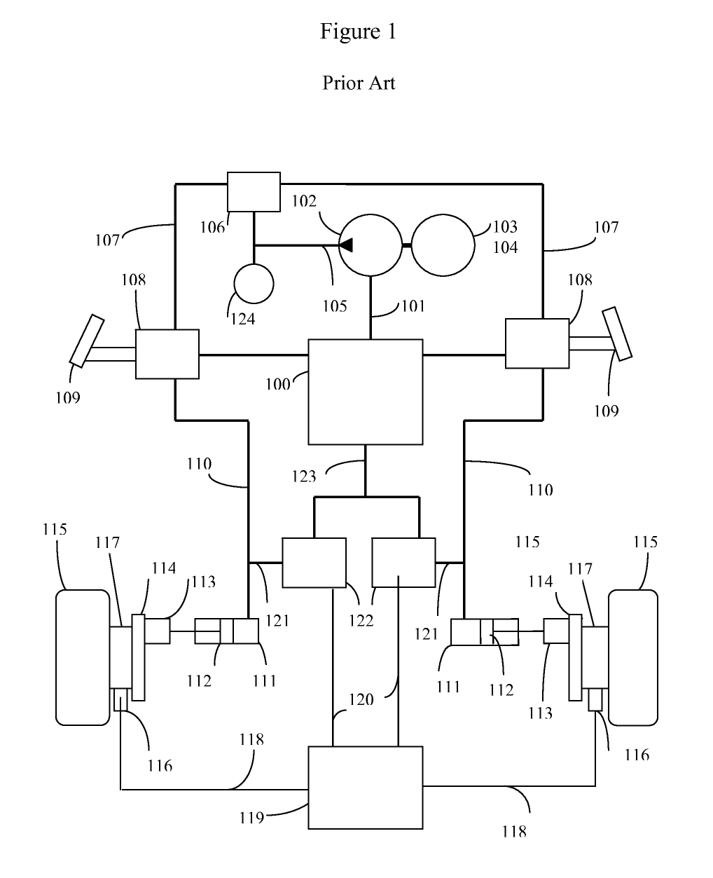

As illustrated by way of example in FIG. 1, today's electronically controlled antiskid systems are not well suited for vehicles with manual brakes because a power source for the brake system must be added to the vehicle. This is not practical due to the added weight, cost and the difficulty of mounting the many needed components. At least some preferred embodiments of the present invention provide the same safety benefits for vehicles with manual brake systems without the need for all of the additional components required for a vehicle with powered brakes. Antiskid systems according to at least some preferred embodiments weigh and cost less and are more compact than antiskid systems for powered brakes since there is no need for a hydraulic or pneumatic pump, a drive motor, control valves, relief valves and piping. In at least some preferred embodiments, the actuator that moves the brake linkage can be located anywhere in the brake linkage system. This can reduce the cost of retrofitting the antiskid system into vehicles already in use. At least some preferred embodiments may also reduce maintenance costs by extending tire life by reducing tire skids and tire blowouts and may reduce the cost of vehicle insurance by reducing the number of accidents caused by loss of directional control when braking

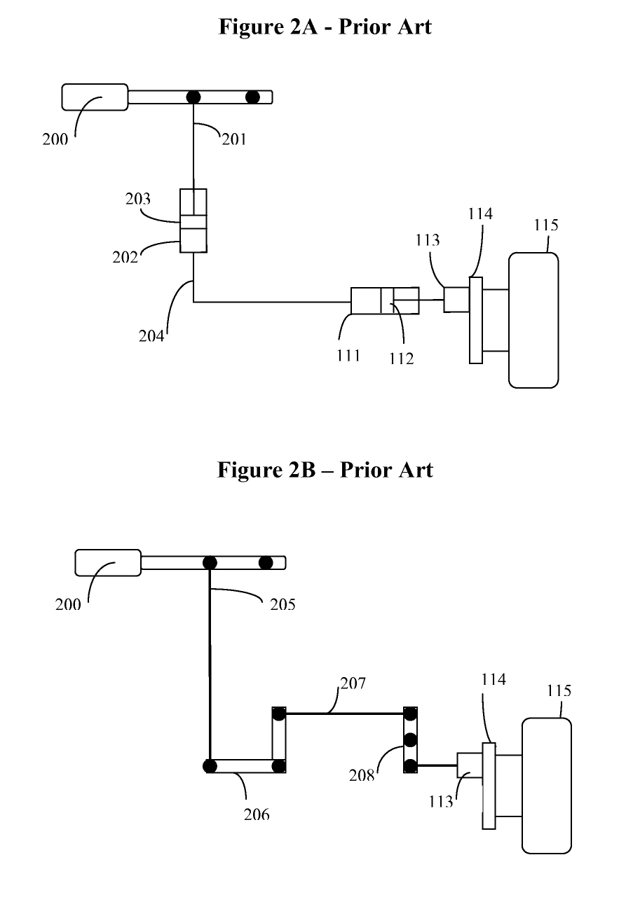

In typical use of at least some preferred embodiments, the manual brake system already in place and certified on a vehicle is not impacted by the addition of the antiskid system. All elements of a manual brake system, shown by way of example in FIGS. 2A and 2B, remain operational on the vehicle when the electronically controlled antiskid system is not operating. This is important for aircraft where re-certifying the entire brake system is impractical due to the added cost and the need to comply with the most current certification requirements. At least some preferred embodiments can be retrofit on vehicles already in operation or may be installed in new production vehicles as they are being manufactured. In some cases, a retrofit can be performed by replacing the current master cylinder with a plug and play replacement called an electric master cylinder.

In at least some preferred embodiments, the electronic controller of the antiskid system for manual brakes can be adapted from electronic controllers for antiskid systems for powered brakes. This includes both analog and digital controller designs that are available today. In addition, antiskid software algorithms for powered brake systems can also be adapted to be used in at least some preferred embodiments. Adapting current antiskid electronics and software for the electronic controller in at least some preferred embodiments is attractive to perspective manufacturers in the antiskid brake business as it can reduce both the development time and cost to manufacture.

Most currently known antiskid controllers compare the wheel speeds of all of the wheels on the vehicle to determine if a skidding event is occurring or about to occur with one or more of the wheels. Some electronic controllers use software algorithms to estimate the vehicle's “reference” or ground speed. Other antiskid controllers use inputs from other systems on board the vehicle to determine the estimated ground or reference speed. A function that can be added to some embodiments of the present invention is a Global Positioning System (GPS) capability that calculates the ground speed of the vehicle using GPS satellite data.

At least some preferred embodiments of the present invention may be implemented with an advanced controller for aircraft and motorcycles applications or a basic controller sufficient for bicycle applications. For example, without limitation, a simple version of the electronic controller may be used on off road bicycles when a cyclist needs to maintain maximum braking and directional control when riding down a step dirt hill. In this non-limiting example, the electronic controller is an ON/OFF switch that the cyclist holds “ON” to engage the antiskid actuator in a “pulse the brakes mode” when the antiskid function is needed.

At least some preferred embodiments of the present invention may utilize either type of automotive wheel speed sensors: the variable-reluctance or the magneto-resistive type of sensor. These sensors are environmentally rugged, lightweight, compact and low cost, and magneto-resistive wheel speed sensors can operate down to zero wheel speeds. Furthermore, wheel speed sensors in at least some preferred embodiments are not mounted inside the axle of the wheel. Wheel speed sensors typically use a gear shaped device called a tone ring to disrupt the magnetic field around the wheel speed sensor. Aircraft wheel speed sensors integrate the tone rings with the senor into a single unit that is mounted inside the aircraft's axle. This is not practical on general aviation aircraft due to the small axle diameters. The wheel speed sensor used in at least some preferred embodiments is located outside the axle. In addition in at least some preferred embodiments, the tone ring can be integrated into the brake disc for vehicles that utilize a disc brake. This is done by forming a gear shape in the outside or inside diameter of the brake disc. This can be done on aircraft, motorcycles or bicycles and can reduce weight and system complexity.

There are several groups of people that could benefit from an electronically controlled antiskid system for vehicles with manual brakes in accordance with at least some preferred embodiments of the present invention. Pilots of general aviation (GA) aircraft can utilize at least some preferred embodiments to increase safety and reduce operating costs. The landing phase of flight has the highest accident rate and loss of direction control is the biggest accident factor in this category. Having an antiskid system available for GA aircraft pilots could improve aircraft safety and increase pilots' peace of mind. Flight schools may also be interested in having the antiskid function according to at least some preferred embodiments on their GA aircraft since they typically experience two blown tires a year per aircraft from excessive braking by students. Manufacturers of GA aircraft with manual brake systems may also be interested in at least some preferred embodiments, as they could create more sales. With at least some preferred embodiments, manufacturers of aircraft brakes and antiskid systems would be able to enter the untapped retrofit market with over 200,000 GA airplanes flying today with manual brakes and no antiskid system available for these aircraft. Motorcycle manufactures may be interested in at least some preferred embodiments for motorcycles with manual brakes as many motorcycle manufacturers continue to provide more safety features on their vehicles, similar to cars to promote safety and increase sales. At least some preferred embodiments would be particularly beneficial for motorcycles that are operated in wet or icy conditions. With at least some preferred embodiments manufacturers of motorcycle brakes would also be able to enter the untapped retrofit market with millions of motorcycles in use today with manual brakes and no antiskid system available for these vehicles. Bicycle manufactures may be interested in at least some preferred embodiments for bicycles operated in wet and icy conditions and for bicycles operated by off-road cyclists that need enhanced skid and directional control when riding their bicycles in the dirt or mud. With at least some preferred embodiments manufacturers of bicycle brakes would be able to enter the untapped retrofit market with millions of bicycles in use today with manual brakes and no antiskid system available for these vehicles.

In a basic embodiment of the present invention, an antiskid system uses an actuator assembly to move a brake linkage to reduce the force that an operator is applying to a brake pad. The actuator assembly that moves the brake linkage utilizes a pulsing motion to reduce the average force that is being applied to the brake pad to reduce or eliminate tire skid. In this basic embodiment, the antiskid system also uses an electronic controller that is an On/Off switch that is actuated by the vehicle's operator to turn on the actuator assembly that pulses the manual brake linkage to reduce or eliminate tire skid. A typical application this embodiment is on a bicycle.

In an advanced embodiment of the present invention, an antiskid system uses an actuator assembly that can set and hold a position of a manual brake linkage to modulate the force on a brake pad. Wheel speed sensors and optional GPS data are used by an electronic controller to detect a skidding event. When a skidding event is detected, the electronic controller automatically commands the actuator to modulate the brake force to reduce tire skid. This advanced embodiment provides more efficient antiskid protection than a basic embodiment. A typical application for the present embodiment is on GA aircraft and motorcycles.

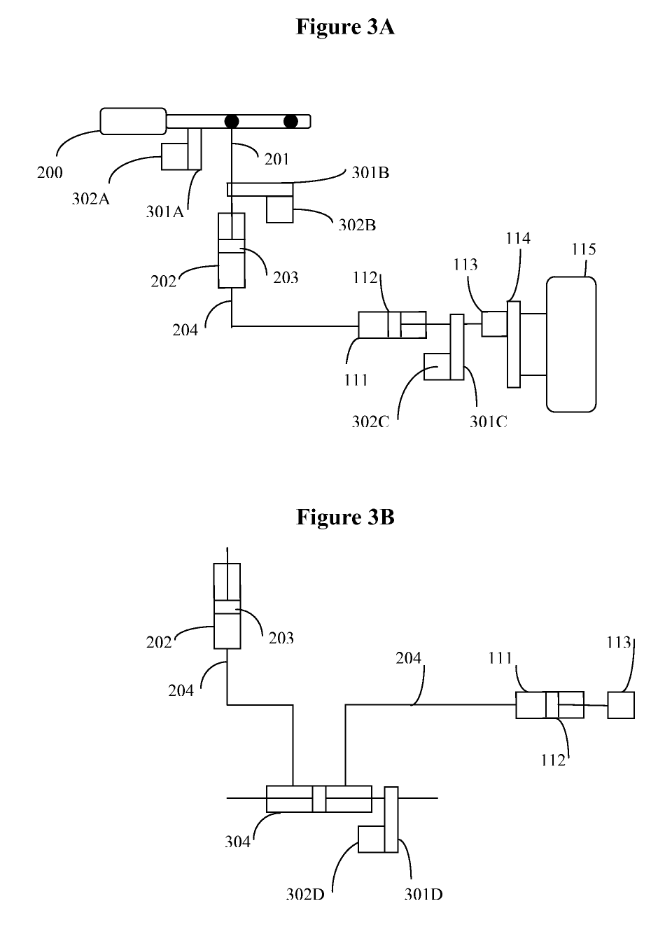

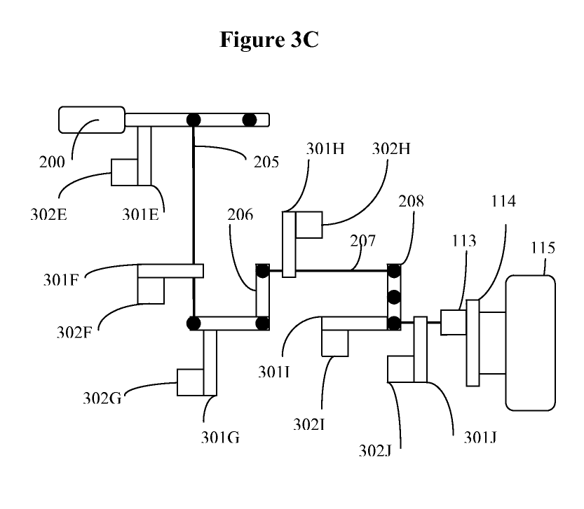

FIGS. 3A, 3B and 3C are schematic diagrams showing an exemplary manual brake system for one wheel on a vehicle, in accordance with an embodiment of the present invention. FIG. 3A is an overall view of a simple hydraulic system with three alternate locations for a lock and release assembly and an actuator assembly, and FIG. 3B is a close-up view of a fourth alternate location for the lock and release assembly and the actuator assembly in the simple hydraulic system. FIG. 3C is an overall view of a more complex mechanical system with six alternate locations for the lock and release assembly and the actuator assembly. The present embodiment may be used on vehicles with two main wheels each with a separate brake and an independent hand or foot brake lever that is used by an operator to actuate and power the brakes. The wheels may be located in the front and rear of these vehicles such as in motorcycles and bicycles, or they may be located on the left and right side of these vehicles such as in GA aircraft.

Referring to FIG. 3A, the brake system uses the force applied to a brake lever 200 by the operator's hand or foot to create the hydraulic brake pressure. Hydraulic pressure is created by transferring the force from the operator's hand or foot to brake lever 200 to an input shaft 201 that is connected to a piston 203 in a hydraulic master cylinder 202. Hydraulic piston 203 is contained in a cavity within master cylinder 202 in such a manner that hydraulic pressure is created in proportion to the force applied to brake lever 200 by the operator's hand or foot. A hydraulic pipe 204 connects master cylinder 202 to a hydraulic brake cylinder 111. Hydraulic brake cylinder 111 comprises a brake piston 112 that is connected to a brake pad 113, which is pushed against a brake disc/drum 114 creating the friction to slow the turning disc/drum 114 that is connected to a wheel 115. This action slows and stops the vehicle.

In the present embodiment, the antiskid system comprises a lock and release assembly, an actuator assembly and an electronic controller. The actuator assembly may comprise a gearmotor and pulses the brake linkage to reduce the average force on the brake pads. The lock and release assembly connects the actuator assembly to the brake linkage when the antiskid function is needed and disconnects the actuator assembly from the brake linkage when the antiskid function is not needed or if there is a loss of electrical power. There is a lock and release assembly for each actuator assembly. The actuator assembly and the lock and release assembly can be powered by the vehicle's electrical system or by a portable battery. The lock and release assembly and the actuator assembly can be located in several positions through out the manual hydraulic brake linkage system. For example without limitation, a lock and release assembly 301A and an actuator assembly 302A are shown mounted at brake lever 200, a lock and release assembly 301B and an actuator assembly 302B are shown mounted near input shaft 201, and a lock and release assembly 301C and an actuator assembly 302C are shown mounted near brake pad 113.

Referring to FIG. 3B, a fourth exemplary location of a lock and release assembly 301D and an actuator assembly 302D is shown mounted in hydraulic piping 204 using a hydraulic cylinder 304. Lock and release assembly 301D may be located anywhere along hydraulic piping 204. In some hydraulic brake system there is limited access to the mechanical linkage. When this is the case, a hydraulic cylinder 304 can be placed any convenient location in the brake line 204 as shown in FIG. 3B. The shaft on the hydraulic cylinder 304 provides a mechanical linkage for connecting actuator assembly 302D and lock and release assembly 301D.

In the present embodiment, the electronic controller used on the manual hydraulic and mechanical brake system is an On/Off Switch that is actuated by the vehicle's operator to turn on actuator assembly 302A, 302B, 302C, or 302D that pulses the manual brake linkage to reduce or eliminate tire skids. The switch also turns on lock and release assembly 301A, 301B, 301C, or 301D to connect actuator assembly 302A, 302B, 302C, or 302D to the brake linkage. A typical application for an electronic controlled antiskid system utilizing an On/Off switch is on a bicycle.

In an alternate embodiment, the system comprises an actuator assembly with a gearmotor that pulses the brake linkage to reduce the average force on the brake pads without a lock and release assembly. There may be an actuator assembly for one or both wheels. The actuator assembly may be powered by the vehicle's electrical system or by a portable battery. The lock and release assembly may be eliminated when the configuration of the brake linkage enables the actuator assembly to engage and disengage the brake linkage without the need for a connection device. This is the case on some bicycle brake systems where the actuator assembly moves the scissor type brake linkages at the brake pads or when the actuator assembly moves the brake handle. When there is no lock and release assembly, a position switch is required to turn off the actuator assembly at its most refracted position.

Referring to FIG. 3C, the manual mechanical brake system for a motorcycle or bicycle is shown. These vehicles have two main wheels each with a separate brake and an independent hand or foot brake levers that are used by the operator to actuate and power the brakes. Only the brake system for the rear wheel is shown; although, there may also be a manual mechanical brake system for the front wheel on motorcycles and bicycles.

In the present embodiment, the vehicle operator provides the power for the actuation of the brakes by pushing or pulling on brake lever 200 with his hand or foot. Brake lever 200 is coupled to a mechanical lever 206 with a rod or cable 205. When the operator pushes or pulls on brake lever 200, mechanical lever 206 pulls or pushes rod or cable 207 that is connected to a mechanical lever 208 that is connected to brake pad 113 by a rod or cable 207. Brake pad 113 is pushed against brake disc/drum 114 creating the friction to slow the turning brake disc/drum 114 that is connected to wheel 115. This action slows or stops the vehicle. In alternate embodiments the number and arrangement of rods, cables and levers may vary depending on the particular geometry of the vehicle.

In the present embodiment, a lock and release assembly, an actuator assembly and an electronic controller is added to the manual mechanical brake system. As in the simple system, the lock and release assembly and the actuator assembly can be located in several positions through out the manual mechanical brake linkage system. For example, without limitation, a lock and release assembly 301E and an actuator assembly 302E are shown mounted near brake lever 200, a lock and release assembly 301F and an actuator assembly 302F are shown mounted along rod or cable 205, a lock and release assembly 301G and an actuator assembly 302G are shown mounted on mechanical lever 206, a lock and release assembly 301H and an actuator assembly 302H are shown mounted along rod or cable 207, a lock and release assembly 301I and an actuator assembly 3021 are shown mounted on mechanical lever 208, and a lock and release assembly 301J and an actuator assembly 302J are shown mounted near brake pad 113.

Hybrid manual brake systems exist that combine hydraulic and mechanical linkages to couple the operator's hand and/or foot movements to operate and power the brake mechanism. The brake pads in these hybrid manual brake systems can be mechanically or hydraulically actuated. In alternate embodiments the features and functions described above for the manual hydraulic and manual mechanical brake systems can be used in their respective locations in these hybrid systems.

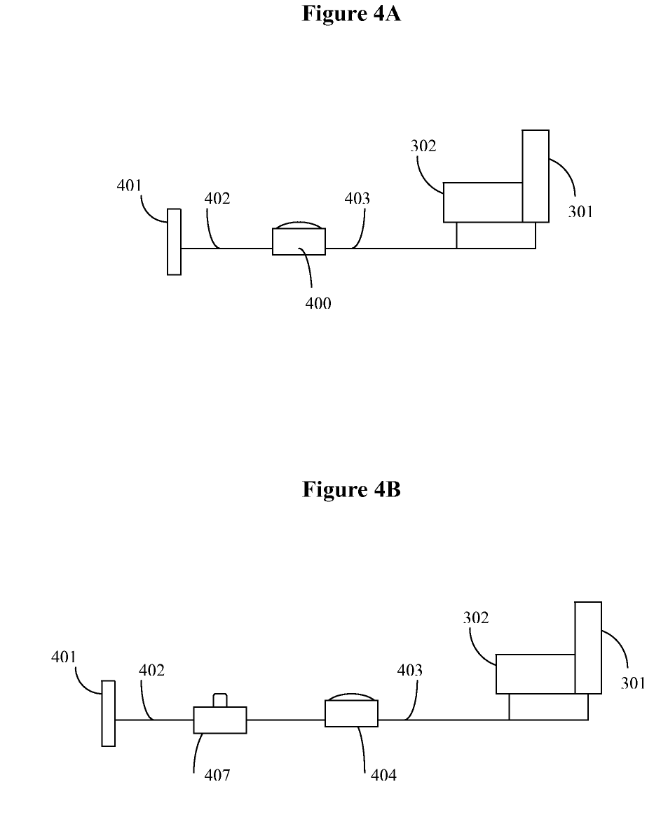

FIGS. 4A and 4B are schematic diagrams illustrating an exemplary electronic controller for an antiskid system for manual brakes, in accordance with an embodiment of the present invention. FIG. 4A shows the electronic control as an On/Off switch 400, and FIG. 4B shows the electronic control with the addition of a rheostat 407. Referring to FIG. 4A, an electricity source 401 is connected to On/Off switch 400 by an electrical cable 402. Electricity source 401 may be various different types of electricity sources such as, but not limited to, a vehicle power source, batteries, etc. On/Off switch 400 supplies a lock and release assembly 301 and an actuator assembly 302 with electrical power through an electrical cable 403. When an operator closes On/Off switch 400, lock and release assembly 301 connects to the brake linkage and actuator assembly 302 pulses the brakes. When the operator opens On/Off switch 400, actuator assembly 302 stops pulsing the brakes and lock and release assembly 301 disconnects from the brake linkage.

In alternate embodiments the functionality of the electronic controller may be increased by replacing On/Off Switch 400 with other types of switches. One alternate embodiment comprises a force switch that is mounted in the brake linkage and closes when a specific brake force is reached. This turns on the actuator assembly and the lock and release assembly connecting the actuator assembly to the brake linkage. When the brake force drops below a specific level, the force switch opens and the actuator assembly stops pulsing the brakes and the lock and release assembly disconnects from the brake linkage. In this embodiment, a separate force switch is required for each actuator assembly.

In another alternate embodiment, a pressure switch is mounted in the hydraulic circuit and closes when a specific brake pressure is reached. This turns on the actuator assembly and the lock and release assembly connecting the actuator assembly to the brake linkage. When the brake pressure drops below a specific level, the pressure switch opens and the actuator assembly stops pulsing the brakes and the lock and release assembly disconnects from the brake linkage. The pressure switch only works with manual hydraulic brake systems. In this embodiment, a separate pressure switch is needed for each actuator assembly.

In another alternate embodiment, an inertia switch is mounted to the vehicle and closes when a specific deceleration level is reached. This switch turns on the actuator assembly and the lock and release assembly connecting the actuator assembly to the brake linkage. When the vehicle's deceleration drops below a specific level, the inertia switch opens and the actuator assembly stops pulsing the brakes and the lock and release assembly disconnects from the brake linkage. Only one inertia switch is needed for all of the actuator assemblies in this embodiment.

In yet another alternate embodiment, On/Off Switch 400 is replaced with a rheostat that is actuated by the vehicle's operator in order to turn on the actuator assembly that pulses the manual brake linkage to reduce or eliminate tire skids. The rheostat enables the operator to vary the voltage, which in turn varies the frequency of the pulses from the actuator assembly. The rheostat also activates and disengages the lock and release assembly. In the present embodiment, a rheostat is need for each actuator assembly.

Referring to FIG. 4B, rheostat 407 is used in the present embodiment in combination with a switch 404. In order to function properly with rheostat 407, switch 404 is preferably a force switch, a pressure switch, or an inertia switch. The vehicle's operator manually controls the speed of the actuator assembly that varies the frequency of the pulses to the brake linkage using rheostat 407. Rheostat 407 is used after switch 404 automatically turns on the actuator assembly. In the present embodiment, a rheostat is needed for each actuator assembly.

In the present embodiment, the electronic controller uses On/Off switch 400 actuated by the vehicle's operator or automatic switch 404 to turn on actuator assembly 302 that pulses the manual brake linkage to reduce or eliminate tire skids. Once actuator assembly is turned on, rheostat 407 may be actuated by the operator to control the pulsing of actuator assembly 302. Switch 400 or 404 also turns on lock and release assembly 301 to connect actuator assembly 301 to the brake linkage. A typical application for an electronic controlled antiskid system in accordance with the present embodiment is in a bicycle.

Alternate embodiments of the present invention may incorporate an electronic controller that increases its functionality by incorporating a wheel speed sensor and a tone ring for each wheel that is coupled to a computing device such as, but not limited to, a smart phone by a wire or wireless connection. The tone ring and brake disc can be integrated into one assembly by making a gear shape on the inside or outside diameter of the brake disc. The wheel speed sensor and tone ring are preferably mounted outside the axle rather than inside the axle. The computing device may also comprise a GPS capability like those found on smart phones. With the use of application software, the computing device may interpret the wheel speed and compare it to the GPS ground speed calculated by the computing device. The electronic controller includes brake release switches for each wheel that enable the operator to manually turn the gearmotors in the actuator assemblies on or off to pulse the brake linkages or to stop the pulsing. Earphones located on the operator's left and right ears are connected to the computing device by wire or wireless connection. When the computing device determines that a wheel is skidding or about to skid, the computing device sends a tone to the left or right ear corresponding to the brake release switch that needs to be turned on to pulse the appropriate brake. The tone continues until the skidding stops to alert the operator to turn off the pulsing. In alternate embodiments a visual signal may be sent to the operator to warn the operator of wheel skidding, for example, without limitation, a flashing light on a control panel. In the present embodiment, the electronic controller can be powered by the vehicle's electrical system or by a portable battery. In some embodiments rheostats can be used instead of On/Off switches to vary the frequency of the pulses to the brake linkage.

The embodiments described in the foregoing are directed to relatively basic implementations of an electronically controlled antiskid system for manual hydraulic and mechanical brake systems. However, the embodiments illustrated by way of example in FIGS. 3A, 3B and 3C may also be implemented as a more advanced system by incorporating an electronic controller with advanced functions.

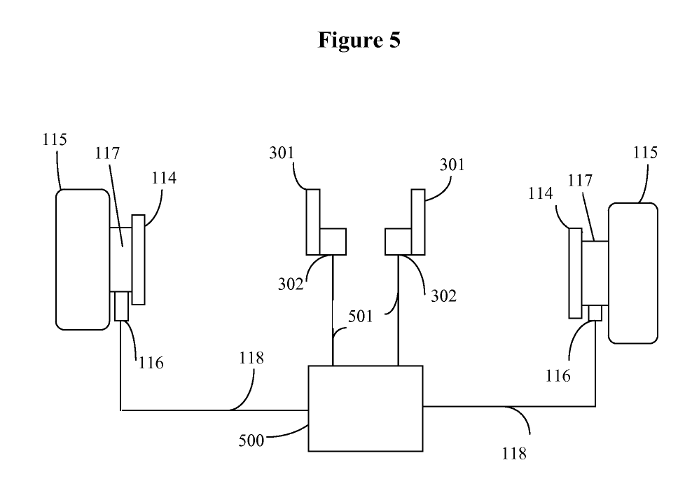

FIG. 5 is a schematic diagram of an exemplary electronic controller 500 in an electronically controlled antiskid system installed on two wheels 115 of a vehicle, in accordance with an embodiment of the present invention. In the present embodiment, the system comprises an actuator assembly 302 to set and hold a position of the brake linkage. This enables advanced electronic controller 500 to modulate the force from the brake pads on brake discs/drums 114. Modulating the force from the brake pads is more effective at preventing tire skids than pulsing the brake pads, which is done in the foregoing embodiments.

In the present embodiment, a switch is not required to actuate the antiskid system. Instead, advanced electronic controller 500 monitors the speed of wheels 115 as detected by wheel speed sensors 116 to determine if one wheel is rotating at a slower speed than the other wheel. Advanced electronic controller has electronic circuitry that can provide the electrical power for wheel speed sensors 116 and receive the wheel speed data for each wheel 115 through electric cables 118. In alternate embodiments the advanced electronic controller may be connected to the wheel speed sensors through a wireless connection. In the present embodiment, a tone ring 117 turns with wheel 115 and creates a magnetic field disruption that can be detected by wheel speed sensors 116 to enable wheel speed sensor 116 to determine the wheel speed. In alternate embodiments, the tone ring and the brake disc/drum can be integrated into one assembly by making a gear shape on the inside or outside diameter of the brake disc/drum. In the present embodiment, wheel speed sensor 116 and tone ring 117 are mounted outside the axle. Based on the difference in wheels speeds and the rate of change of the wheel speeds, advanced electronic controller 500 determines if a skid event is occurring or about to occur. Advanced electronic controller 500 also may use an optional Global Positioning Signal (GPS) to calculate the vehicle's ground or reference speed. This feature enhances the ability of advanced electronic controller 500 to detect and control skidding events.

When advanced electronic controller 500 detects a skidding event, it automatically commands a lock and release assembly 301 to connect actuator assembly 302 to the brake linkage system. Advanced electronic controller 500 then commands actuator assembly 302 to move the brake linkage a specific distance. When the brake linkage is moved, the force on the brake pads is reduced. No matter how hard the vehicle's operator pushes or pulls on the brake lever, it cannot be converted into a force on the brake pads because the brake linkage is generally prevented from moving. Once the skid is prevented, reduced or eliminated, advanced electronic controller 500 de-energizes lock and release assembly 301, which disconnects actuator assembly 302 from the brake linkage system, and actuator assembly 302 is commanded by advanced electronic controller 500 to return to its home position. With the antiskid system in its standby mode, the manual hydraulic or mechanical brake system remains fully functional until a new skid event is detected and the antiskid process is repeated again. The antiskid system remains in standby mode as long as the antiskid function is not needed or if there is a loss of electrical power. In an alternate embodiment, an advanced electronic controller may be used to pulse the actuator assembly rather than modulating the force on the brake pads.

An advantage of the advanced form of electronic controller 500 for an antiskid system for manual brakes is that electronic controller 500 can be adapted from the electronic controllers for antiskid systems for powered brakes. This includes both analog and digital controller designs that are available today. In addition, antiskid software algorithms for powered brake systems can also be adapted to be used with electronic controller 500. Adapting current antiskid electronics and software for electronic controller 500 makes it attractive to perspective manufacturers in the antiskid business as it will reduce both the development time and cost if they are licensed to produce an antiskid system according to the present embodiment. Advanced electronic controller 500 also has the computing power to capture and annunciate faults with the antiskid system. Advanced electronic controller 500 also provides an interface connection with the antiskid control panel located at the operator's station. Advanced electronic controller 500 may be powered by the vehicle's electrical system or by a portable battery.

In the present embodiment, actuator assembly 302 moves the brake linkage to reduce the force that is being applied to the brake pads and thus reduce or eliminate the tire skid. Actuator assembly 302 must have enough power to overcome the input force being applied by the operator's hand or foot. As shown by way of example in FIGS. 3A, 3B and 3C, actuator assembly 302 can be located in several locations throughout the hydraulic or mechanical brake linkage system. The power needed to overcome the mechanical leverage depends on where actuator assembly 302 is located in the brake linkage system. Actuator assembly 302 only needs to move the brake pad a small distance to reduce the force on brake disc/drum 114. For example, without limitation, testing has shown that when actuator assembly 302 is connected to the input shaft of the master cylinder, the input shaft must only move 0.07 inches to reduce the pressure from 400 PSI to 50 PSI.

Electricity is the primary source of power for actuator assembly 302. Power may be provided from the vehicle's electrical system, the vehicle's battery, or a portable battery through advanced electronic controller 500. Advanced electronic controller 500 is connected to lock and release assembly 301 and actuator assembly 302 through an electric cable 501. Vehicles with manual brake systems that have an electrical system usually have a Direct Current (DC) system. Consequently, actuator assembly 302 typically uses DC electricity. However, Alternating Current (AC) electricity can also be used with actuator assembly 302 by converting the vehicle's DC electrical power to AC electrical power for the antiskid system. Actuator assembly 302 is typically driven by an electric motor; however, a hydraulic or pneumatic motor can also drive actuator assembly 302. When a hydraulic or pneumatic motor is used, an electric motor drives a hydraulic or pneumatic pump that in turn drives the hydraulic or pneumatic motor that drives actuator assembly 302. Power can also be provided from an accumulator or tank that contains compressed gas that can drive a hydraulic or pneumatic motor. The accumulator can directly power a hydraulic or pneumatic cylinder. The motors that drive actuator assembly 302 in most implementations use a gearbox to reduce the speed and increase the torque of the output shaft of the motor. The gearbox can be integral with the motor or can be independent from the motor. The function of actuator assembly 302 is to move the brake linkage a small distance to reduce the force on the brake pad. Therefore, the electric, hydraulic or pneumatic motors, with and without gearboxes, in some cases must convert their rotary output motion into a linear motion.

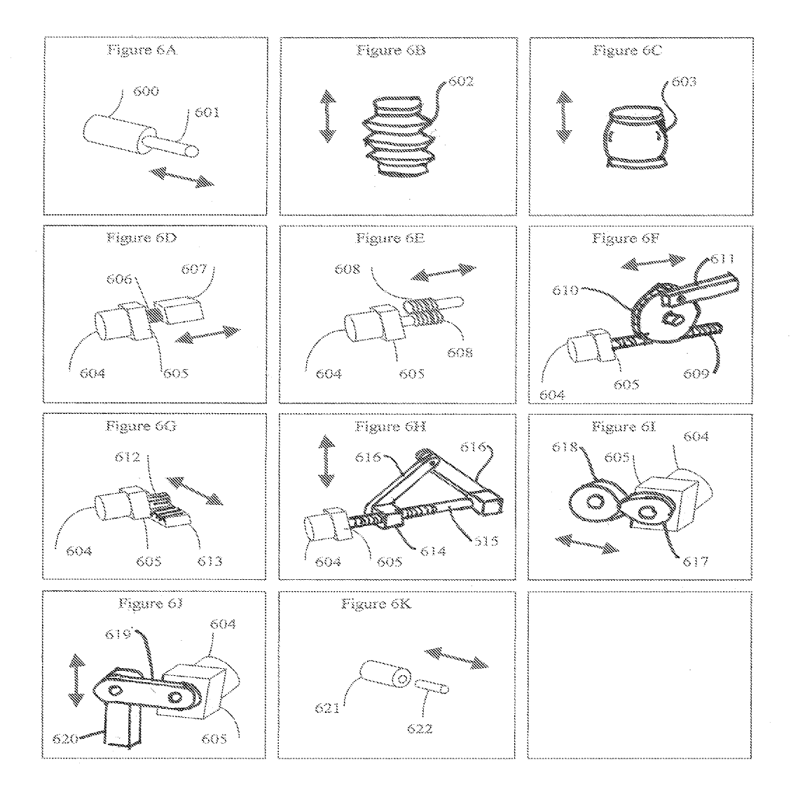

FIGS. 6A through 6K illustrate eleven different exemplary methods to drive an actuator assembly, in accordance with embodiments of the present invention. FIG. 6A shows a piston. FIG. 6B shows a bellows actuator 602. FIG. 6C shows an inflatable accumulator 603. FIG. 6D shows a motor 604 with a screw 606. FIG. 6E shows motor 604 with helical gears 608. FIG. 6F shows motor 604 with a worm gear 609. FIG. 6G shows motor 604 with a gear 612 and a gear rack 613. FIG. 6H shows motor 604 with scissor arms 616. FIG. 6I shows motor 604 with a cam 617. FIG. 6J shows motor 604 with a lever arm 619. FIG. 6K shows an electric solenoid 621. Any of these methods can be used with an electronically controlled antiskid brake system for manual brakes to drive the actuator assembly.

FIGS. 6A through 6C show three methods for converting hydraulic or pneumatic power into a linear motion. Referring to FIG. 6A, a cylinder 600 comprises a piston inside to drive an output shaft 601 in a linear motion. Referring to FIG. 6B, bellows actuator 602 expands or contracts with the hydraulic or pneumatic power exerted onto it to convert this power into a linear motion. Referring to FIG. 6C, inflatable accumulator 603 converts hydraulic or pneumatic power into a linear motion in the same manner as bellows actuator 602.

FIGS. 6D through 6J use motor 604 to drive the actuator assembly. Motor 604 can be electric, hydraulic or pneumatically powered. Motor 604 uses a gearbox 605 to reduce the speed of the output shaft and increase the torque; however, all of these methods may be implemented without a gearbox. Motor 604 turns continuously and has the ability to reverse its rotation. Motor 604 and gearbox 605 convert the rotary motion of the output shaft of motor 604 into a linear motion to move the brake linkage. Referring to FIG. 6D, a nut 607 moves along screw 606 to convert the rotary motion of screw 606 into linear motion. Referring to FIG. 6E, two helical gears 608 interconnect so that the rotation of one helical gear 608 translates into the linear motion of the other helical gear 608. Referring to FIG. 6F, worm gear 609 interconnects with a worm wheel 610 to drive a connecting rod 611 in a linear motion. Referring to FIG. 6G, gear 612 and gear rack 613 interconnect so that the rotation of gear 612 moves gear rack 613 in a linear motion. Referring to FIG. 6H, scissor arms 616 are connected to motor 604 with a screw 615 and a nut 614. As screw 615 rotates, nut 614 moves along screw 615 and scissor arms 616 move up and down. Referring to FIG. 6I, cam 617 rotates, moving a cam follower 618 in a linear motion. Referring to FIG. 6J, lever arm 619 drives a connecting rod 620 in a linear motion.

Referring to FIG. 6K, electric solenoid 621 pulls or pushes an armature 622 with a magnetic field. Armature 622 moves the brake linkage.

Those skilled in the art, in light of the present teachings, will readily recognize that a multiplicity of other suitable means may be used to drive the actuator assembly in alternate embodiments. For example, without limitation, an electric servomotor may be used to drive the actuator assembly. The servomotor utilizes an electric motor coupled to a gearbox that has an electronic sensor that monitors the rotation and position of the output shaft of the gearbox. With the use of an electronic servo controller, the output shaft of the servomotor can be commanded to rotate a specific distance and hold that position.

In other non-limiting examples, the actuator assembly may utilize the independent elements described above and couple them together in various configurations. These elements can include, without limitation, combinations of electric motors, hydraulic or pneumatic pumps and motors, many different devices to convert rotary to linear motion, solenoids, hydraulic or pneumatic actuators and servomotors. These elements may also be integrated into sub-assemblies or complete assemblies to form the actuator assembly.

At least some preferred embodiments of the present invention may utilize one of two types of actuator assemblies. For example, without limitation, in a basic implementation, the actuator assembly 302 pulses the brakes by moving the brake linkage back and forth a short distance at a rate of several times a second. The linear actuators described above by way of example with respect to FIGS. 6D through 6H can pulse the brake linkages by reversing motor 604 several times a second. If a hydraulic or pneumatic cylinder is used to pulse the brake linkage as shown by way of example in FIGS. 6A through 6C, a control valve is needed to change the linear direction of cylinder 600. When a cam is used to convert the rotary motion of the output shaft of motor 304 into a linear motion as shown by way of example in FIG. 6I, motor 304 does not need to be reversed to pulse the brake linkage. Electric solenoid 621 can be used to pulse the brake linkage by turning solenoid 621 on and off. In more advanced implementations, the actuator assembly utilizes a servomotor that the electronic controller can command to move the brake linkage a specific distance and hold a position. When the brake system linkage is moved, the force on the brake pads is reduced. No matter how hard the vehicle's operator pushes or pulls on the brake lever, the force cannot be converted into a force on the brake pads because the brake system linkage is generally prevented from moving.

In at least some preferred embodiments the lock and release assembly connects the actuator assembly to the brake linkage. This connection is made when the antiskid function is needed to reduce the force on the brake pads to reduce or eliminate tire skids. The lock and release assembly must have enough power to connect it to the brake linkage and support the force applied by the actuator assembly. As shown by way of example in FIGS. 3A, 3B and 3C, the lock and release assembly can be located in several locations throughout the hydraulic or mechanical brake linkage. The power required to overcome the mechanical leverage depends on where the lock and release assembly is located in the brake linkage. Testing has shown that when the actuator assembly is connected to the input shaft of the master cylinder, the lock and release assembly must support a maximum force of approximately 225 pounds, which equates to 600 PSI. This is roughly 50% more pressure than the maximum operating pressure of the manual hydraulic brake system. When the antiskid function is no longer needed, the lock and release assembly disconnects the actuator assembly from the brake linkage. This enables the normal manual brake operation to resume. On some vehicles, the release function must occur even when there is a power failure. In these cases a spring release is used that operates under the maximum load conditions. This is referred to as a fail-safe mode.

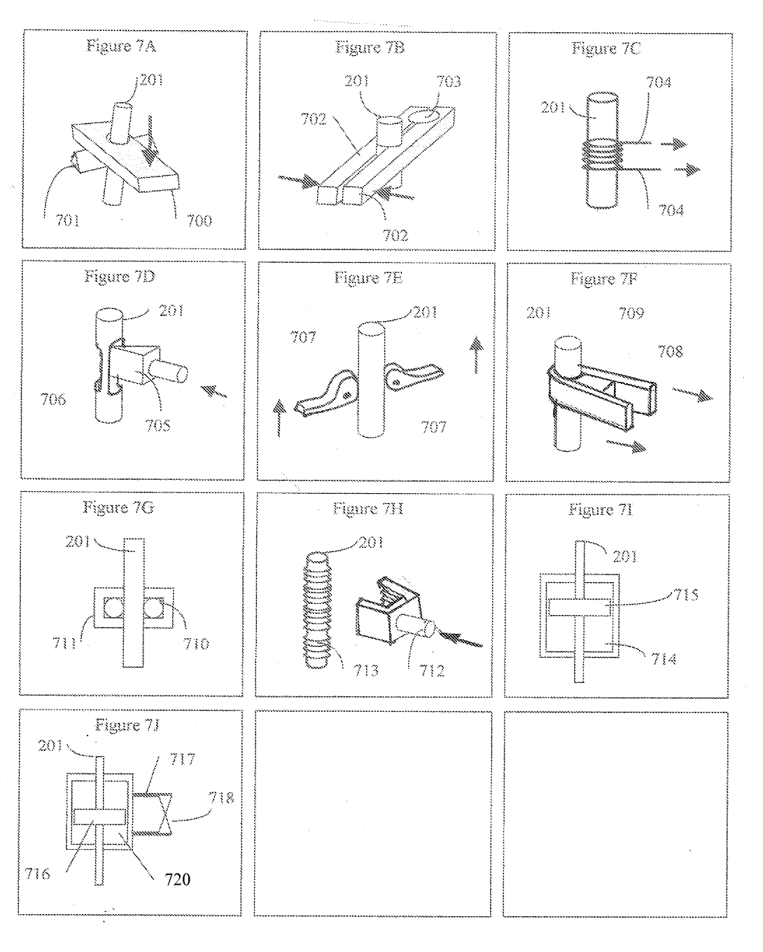

FIGS. 7A through 7J illustrate ten different exemplary methods of connecting a lock and release assembly to a brake linkage shaft 201, in accordance with embodiments of the present invention. FIG. 7A shows a locking tab method. FIG. 7B shows a locking clamp method. FIG. 7C shows a wire lock method. FIG. 7D shows a tapered wedge method. FIG. 7E shows a dual cam lock method. FIG. 7F shows a strap clamp method. FIG. 7G shows a locking collar method. FIG. 7H shows an external fork method. FIG. 7I shows an iron particle method, and FIG. 7J shows a hydraulic piston method. Referring to FIG. 7A, a hole in a locking tab 700 connects locking tab 700 to brake linkage shaft 201 when one end of locking tab 700 is moved in a parallel direction to brake linkage shaft 201. The diameter of the hole is slightly larger than brake linkage shaft 201. The thickness of locking tab 700 is preferably sized to create enough locking force while providing enough material not to deform under load. A pivot edge 701 partially establishes the force that is required to release locking tab 700. Varying the distance from brake linkage shaft 201 to pivot edge 701 changes the force required to release locking tab 700.

Referring to FIG. 7B, two jaws made of metal or other high strength material connect to brake linkage shaft 201 when the jaws are moved towards each other to create a locking clamp 702. A pivot point 703 located close to brake linkage shaft 201 creates additional leverage when the other end of the jaws of locking clamp 702 are brought together.

Referring to FIG. 7C, a wire lock 704 is created by wrapping a coil of wire around brake linkage shaft 201 and pulling tightly on both ends of the wire. Referring to FIG. 7D, a tapered wedge 705 is inserted into a tapered groove 706 to make a firm connection with brake linkage shaft 201. Referring to FIG. 7E, a dual cam lock 707 firmly connects to brake linkage shaft 201 when the cams are rotated. Referring to FIG. 7F, the ends of a strap 708 are pulled tight in relation to a support collar 709 to connect to brake linkage shaft 201. Referring to FIG. 7G, a locking collar 711 is connected to brake linkage shaft 201 by inflating a ring 710 with air or fluid.

Referring to FIG. 7H, a tapered fork 712 is placed over the outside diameter of brake linkage shaft 201. The outside diameter of brake linkage shaft 210 and the inside surface of tapered fork 712 may have matching grooves 713 to increase the integrity of the connection.

Referring to FIG. 7I, brake linkage shaft 201 comprises a piston 715 attached to brake linkage shaft 201 inside a cylinder 719. Also inside cylinder 719 are iron particles 714 that become rigid when electrified. When iron particles 714 are electrified, cylinder 719 locks to piston 715 and brake linkage shaft 201.

Referring to FIG. 7J, a hydraulic piston 716 connects to brake linkage shaft 201. This is done by preventing hydraulic fluid 720 from flowing freely in interconnected pipes 717 when a valve 718 is closed. Piston 716 connected to brake linkage shaft 210 is unable to move when fluid 720 is locked in place.

Those skilled in the art, in light of the present teachings, will readily recognize that a multiplicity of different suitable means may be used to connect the lock and release assembly the brake linkage, which enables the actuator assembly to move the brake linkage and reduce the force on the brake pads.

The lock and release assembly in at least some preferred embodiments requires an actuator to connect and disconnect it from the brake linkage. Electricity is the primary source of power for the lock and release assembly. Power may be provided from the vehicle's electrical system, the vehicle's battery, or a portable battery. Vehicles with manual brake systems that have an electrical system typically have a Direct Current (DC) system. Therefore, the lock and release assembly normally uses DC electricity. However, alternating current (AC) electricity can also be utilized to power the lock and release assembly. The lock and release assembly can be driven by an electric motor. A hydraulic or pneumatic motor can also drive the lock and release assembly. When a hydraulic or pneumatic motor is used, an electric motor drives a hydraulic or pneumatic pump that in turn drives the hydraulic or pneumatic motor that drives the lock and release assembly. Power can also be provided from an accumulator or tank that contains compressed gas that can drive a hydraulic or pneumatic motor. The accumulator can also directly power a hydraulic or pneumatic cylinder to operate the lock and release assembly.

When motors are used to drive the lock and release assembly, the motors in most cases use a gearbox to reduce the speed and increase the torque of the output shaft of the motor. The gearbox can be integral with the motor or it can be independent from the motor. The lock and release assembly may use an electric, hydraulic or pneumatic motor, with or without a gearbox, and in some cases the rotary output motion of the motor must be converted into a linear motion. FIGS. 6D through 6J illustrate seven exemplary methods for converting the rotary motion of the output shaft of a motor or gearbox to a linear motion. Any of these methods or other methods may be used with the lock and release assembly to convert the rotary motion of a motor or gearbox to a linear motion to move the brake linkage. For example, without limitation, when a hydraulic or pneumatic source of power is available, a hydraulic or pneumatic cylinder can be used to operate the lock and release assembly. These cylinders can utilize a piston, bellows or inflatable bag to convert the hydraulic or pneumatic energy into a linear motion, as shown by way of example in FIGS. 6A through 6C. An electric solenoid can also be used to operate the lock and release assembly by applying electrical power to a coil, which moves an armature with its magnetic field to move the lock and release assembly, as illustrated by way of example in FIG. 6K. The lock and release assembly can utilize the independent elements described above and couple them together in various different combinations. These elements may include, without limitation, combinations of electric motors, hydraulic or pneumatic pumps and motors, many different devices to convert rotary to linear motion, solenoids, hydraulic or pneumatic actuators and servomotors. These elements can also be integrated into sub-assemblies or complete assemblies to form the lock and release assembly.

As described in foregoing, there are many methods for incorporating the lock and release assembly and the actuator assembly for an electronically controlled antiskid system for vehicles with manual brakes in accordance with at least some preferred embodiments of the present invention. The following description outlines a preferred method of incorporating the lock and release assembly and the actuator assembly in a manual hydraulic brake system. On manual hydraulic brake systems, the master cylinder, the lock and release assembly and the actuator assembly can be combined into an integrated package that is referred to herein as an electric master cylinder (EMC). The master cylinder in the integrated package maintains the same geometry and retains the same functions as the manual master cylinder that has been certified for the vehicle. This enables the original manual brake system to remain certified and fully functional when the electronic controlled antiskid system is not operating.

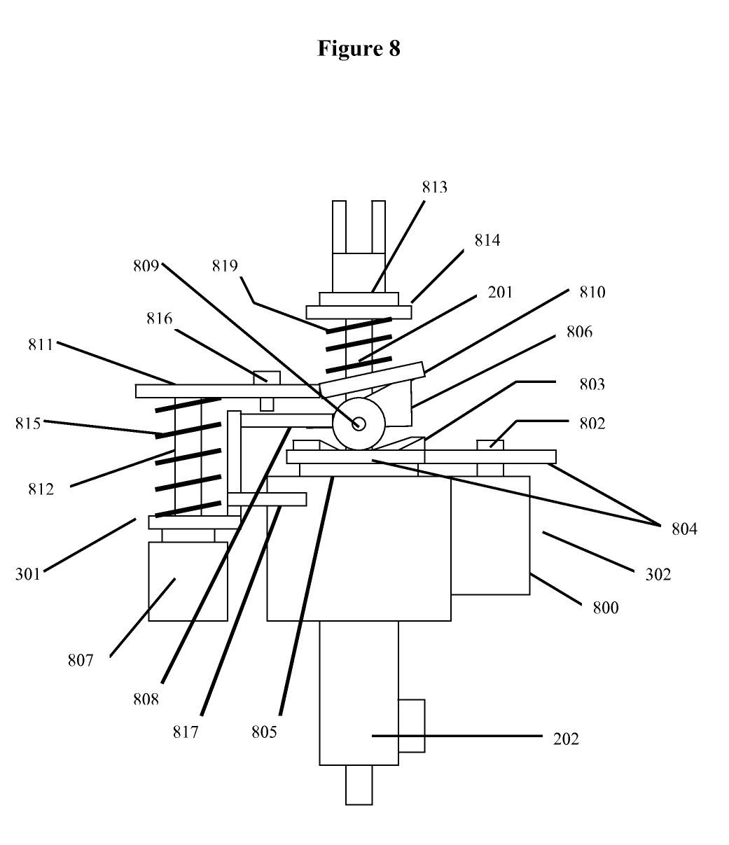

FIG. 8 is a side view of an exemplary electric master cylinder (EMC) with an integrated actuator assembly 302, in accordance with an embodiment of the present invention. In the present embodiment, the EMC comprises a motor 800 to control the movements of an input shaft 201. Motor 800 in the EMC may one of two different types of electrical motors. The first type is a servomotor that supports an advanced implementation because the servomotor can rotate an output shaft 802 to a specific position as directed by an electronic controller. This controls the distance that input shaft 201 moves, giving the system the ability to modulate the hydraulic brake pressure. This pressure modulation feature increases the efficiency of the antiskid system.

The second type of motor that can be used on the EMC is a gearmotor. When energized, the gearmotor rotates continuously. This in turn rotates a cam 803 continuously raising and lowering input shaft 201 a set distance. The gearmotor “pulses” the brakes to reduce tire skidding. Because the hydraulic brake pressure cannot be modulated, the gearmotor configuration is a less efficient antiskid system compared to the servomotor configuration. A position switch is required to stop the gearmotor when the cam is in its lowest position.

In the present embodiment, electric motor 800 is attached to a master cylinder 202. Attached to output shaft 802 of motor 800 is a drive train 804. Drive train 804 couples output shaft 802 of motor 800 to cam 803. Several different types of drive trains can be used such as, but not limited to, gears (as shown), sprockets and chain, belts and pulleys, etc. Any of these drive trains may be used with either a servomotor or a gearmotor. In addition, the servomotor can use a push/pull rod to connect output shaft 802 to cam 803 because the output shaft of a servomotor only rotates approximately 90 degrees.

One end of drive train 804 is centrally located about output shaft 802 of motor 800 and the other end is centrally located about input shaft 201 of master cylinder 202. Mounted under cam 803 is a thrust bearing 805. Thrust bearing 805 reduces the friction and torque in drive train 804 from the force applied to input shaft 201 from a brake lever by an operator's hand or foot. Attached to drive train 804 and located at input shaft 201 is cam 803. Cam 803 uses ramps to raise and lower cam followers 806 when drive train 804 is rotated by motor 800. Cam 803 has one ramp for each cam follower 806. The slope of the ramps determines the rate and amount of modulation or pulsing on the brake system's hydraulic pressure. In the present embodiment, actuator assembly 302 comprises motor 800, output shaft 802, cam 803, drive train 804, and thrust bearing 805, and these items can be located radially in any position about input shaft 201 to create a compact design to facilitate the retrofit replacement of the manual master cylinder 202 with the integrated EMC in the vehicle.

In the present embodiment, a lock and release assembly 301 is also integrated into the EMC. Lock and release assembly 301 comprises cam followers 806 an electric lock solenoid 807, a mounting block 808, axles 809, a pivot edge 810, a lock tab 811, a lock solenoid armature 812, a nut 813, a washer 814 a release spring 815, a fastener 816, and anti-rotation ears 817. Lock and release assembly 301 can be located radially in any position about input shaft 201 to create a compact design to facilitate the retrofit replacement of the manual master cylinder 202 with the EMC. Lock and release assembly 301 connects actuator assembly 302 to input shaft 201 when there is a skidding situation. Electric lock solenoid 807 is energized by the electronic controller when lock and release assembly 301 needs to connect to input shaft 201 when the brake pressure must be lowered to generally prevent, reduce or eliminate a tire skid. The electrically actuated lock solenoid 807 is used in the present embodiment so that, if there is a loss of electrical power, the antiskid system automatically disconnects from input shaft 201 and the manual brake system remains fully operational. However, in alternate embodiments the lock and release assembly may use other connection means such as, but not limited to, those shown by way of example in FIGS. 6A through 6J. In the present embodiment, lock and release assembly 301 is integrated with manual master cylinder 202 and is centrally located about input shaft 201 of master cylinder 202. Lock and release assembly 301 comprises at least two cam followers 806 equally spaced around input shaft 201. Multiple cam followers 806 are needed to generally prevent side loading of input shaft 201 when cam 803 is rotated and input shaft 201 is raised and lowered. Cam followers 806 ride on the ramps of cam 803. When cam 803 is rotated by motor drive assembly 804, cam followers 806 are raised and lowered by rolling up and down the ramps of cam 803.

A mounting block 808 is required to secure cam followers 806 and lock solenoid 807 together as a single unit. Mounting block 808 has a vertical hole through it that centrally locates it about input shaft 201. Rocking of mounting block 808 about input shaft 201 is preferably minimized by having a close tolerance hole for input shaft 201 with a sufficient length to diameter ratio. Protruding from mounting block 808 are axles 809, which are used to attach cam followers 806 to mounting block 808. Mounting block 808 comprises pivot edge 810 located a short distance from input shaft 201. This distance partially determines the lock and release loads for lock tab 811. Also attached to mounting block 808 is lock solenoid 807. Lock tab 811 comprises a hole that centrally locates lock tab 811 about input shaft 201. The diameter and thickness of the hole are sized to create the necessary lock and release loads of lock tab 811. Lock tab 811 comprises a feature at one end to facilitate the attachment of lock solenoid armature 812. In the present embodiment, lock solenoid 807 is attached to mounting block 808 in such a way that lock solenoid 807 can be adjusted vertically to create the desired pull force with lock solenoid armature 812, which is attached to lock tab 811. When electrical power is applied to lock solenoid 807, a magnetic force is created that pulls lock solenoid armature 812 into lock solenoid 807. This pulls lock tab 811 towards lock solenoid 807, which secures lock tab 811 to input shaft 201.

A hold down spring 819 is centrally located about input shaft 201. Hold down spring 819 is retained on input shaft 201 with nut 813 and washer 814. Hold down spring 819 generally ensures that lock tab 811 remains seated against pivot edge 810 in both the locked and released modes of operation. Hold down spring 819 also generally ensures that lock and release assembly 301 returns to its lowest position when lock solenoid 807 is de-energized. Release spring 815 located between solenoid mounting block 808 and lock tab 811 generally ensures that lock tab 811 releases from input shaft 201 when lock solenoid 807 is de-energized. Release spring 815 is retained in the proper position by placing it over lock solenoid armature 812. Release spring 815 provides a fail-safe mode when used in conjunction with electric solenoid 807. The movement of lock tab 811 is restricted by fastener 816. Anti-rotation ears 817 are part of master cylinder 202 and generally prevent lock and release assembly 301 from rotating about input shaft 201 when the actuator assembly 302 is operating.

In some embodiments the hydraulic cylinder, shown by way of example in FIG. 3B, may use the same elements of the EMC to create an integrated package combining the hydraulic cylinder 304, the lock and release assembly 301 and the actuator assembly 302.

Testing of a prototype EMC has shown that 38 watts of electrical power is used to operate both lock and release assembly 301 and actuator assembly 302. This level of power consumption is achieved at a proof pressure of 600 PSI, which is 50% higher than the maximum operating pressure of master cylinder 202. Actuator assembly 302 and lock and release assembly 301 work against a force on input shaft 201 of 225 pounds to attain the 600 PSI of brake pressure. Testing of the prototype EMC has also revealed that hydraulic brake pressure may be modulated at a rate of 1000 PSI per second and the pressure may be set within 10 PSI using a servomotor. The total weight for lock and release assembly 301 and actuator assembly 302 in the present embodiment is less than one pound.

In at least some preferred embodiments, the function of a wheel speed sensor is to provide a signal to an electronic controller that can be used to determine the speed that the wheel is turning. There are two types of wheel speed sensors that can be used in an electronically controlled antiskid system for vehicles with manual brakes. The first type is a variable-reluctance sensor. The disadvantage of the variable-reluctance sensor is the decreasing signal strength as the wheel rotation slows. This means that the antiskid function cannot operate below a vehicle speed of approximately 10 miles per hour due to an insufficient signal from the wheel speed sensor. The second type of wheel speed sensor is an active or magneto-resistive sensor. This type of sensor cannot generate a signal on its own and needs input power from the electronic controller to operate. However, an advantage of the magneto-resistive type of wheel speed sensor is that it can operate down to zero wheel speed. This means the antiskid function can work down to zero vehicle speed making the antiskid function available during both high and low speeds.

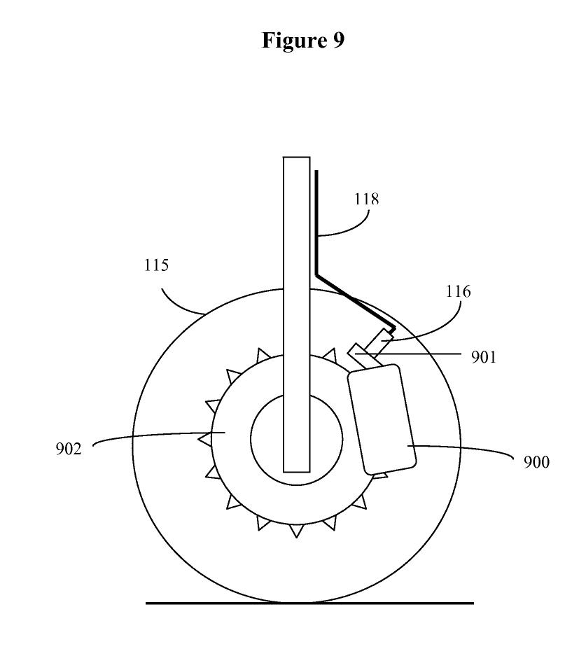

FIG. 9 is a side view of an exemplary wheel speed sensor 116 attached to a brake caliper 900 located on a main wheel 115, in accordance with an embodiment of the present invention. In the present embodiment, wheel speed sensor 116 is connected to brake caliper 900 using a bracket 901. Bracket 901 can be an integral part of brake caliper 900 or it can be a separate item that is attached to brake caliper 900. An electrical cable 118 with suitable conductors and shielding transmits electrical power from an electronic controller to wheel speed sensor 116. The same electrical cable 118 transmits the wheel speed signal from sensor 116 to the electronic controller.

The variable-reluctance and magneto-resistive types of wheel speed sensors both require a gear-shaped tone ring to operate. When the tone ring rotates near a wheel speed sensor of either type, a magnetic field fluctuates around the sensor. The electronic controller interprets the voltage and frequency variation sent from sensor 116 and converts this information into a speed of rotation of wheel 115. In the present embodiment, the tone ring is incorporated into a brake disc 902 by cutting a gear shape into the outside circumference of brake disc 902. This enables brake disc 902 to perform the function of a tone ring. In alternate embodiments the gear shape may be cut into the inside diameter of the brake disc. In the present embodiment, wheel speed sensor 116, attached to brake caliper 900, and brake disc 902, which functions as a tone ring, are externally mounted to the axle of wheel 115.

Having fully described at least one embodiment of the present invention, other equivalent or alternative methods of providing an electronically controlled antiskid braking system for vehicles with manual brakes according to the present invention will be apparent to those skilled in the art. The invention has been described above by way of illustration, and the specific embodiments disclosed are not intended to limit the invention to the particular forms disclosed. For example, the particular implementation of the antiskid system may vary depending upon the particular type of vehicle used. The vehicles described in the foregoing were directed to two wheeled implementations; however, similar techniques are to provide antiskid systems for vehicles with manual brakes that have fewer or more wheels such as, but not limited to, unicycles, tricycles, three wheeled motorcycles, all terrain vehicles (ATVs), etc. Non-two wheeled implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
means for controlling a movement of a manual mechanical linkage shaft in a manual brake system for a vehicle wheel; and
means for directing said actuator assembly to control said movement of the manual mechanical linkage shaft during a braking of the vehicle wheel where said control of said movement mitigates skidding of the vehicle wheel during the braking.

2. The apparatus as recited in claim 1, further comprising means for engaging and disengaging said controlling means to and from the manual mechanical linkage shaft.

3. The apparatus as recited in claim 1, further comprising means for driving said controlling means where a manually applied force to the manual mechanical linkage shaft is modulated to mitigate the skidding of the vehicle wheel during the braking.

4. The apparatus as recited in claim 2, further comprising means for actuating said engaging and disengaging means.

5. The apparatus as recited in claim 4, further comprising means for forming a unit suitable for replacing a manual hydraulic master cylinder of the manual brake system.

6. The apparatus as recited in claim 1, further comprising means for enabling the apparatus to be added to a hydraulic line of the manual brake system.

7. An apparatus comprising:
an actuator assembly configured for controlling a movement of a manual mechanical linkage shaft in a manual brake system for a vehicle wheel; and
an electronic controller for directing said actuator assembly to control said movement of the manual mechanical linkage shaft during a braking of the vehicle wheel where said control of said movement mitigates skidding of the vehicle wheel during the braking.

8. The apparatus as recited in claim 7, further comprising a lock and release assembly configured for engaging and disengaging said actuator assembly to and from the manual mechanical linkage shaft.

9. The apparatus as recited in claim 7, wherein the apparatus is configured as an addition to the manual brake system.

10. The apparatus as recited in claim 7, further comprising an electric servomotor for driving said actuator assembly where, under direction of said electronic controller, a manually applied force to the manual mechanical linkage shaft is modulated to mitigate the skidding of the vehicle wheel during the braking.

11. The apparatus as recited in claim 7, wherein said actuator assembly comprises a cam and cam followers disposed about the manual mechanical linkage shaft for moving the manual mechanical linkage shaft.

12. The apparatus as recited in claim 8, wherein said lock and release assembly comprises a locking tab comprising a hole and a pivot point configured for engaging said actuator assembly to the manual mechanical linkage shaft.

13. The apparatus as recited in claim 8, further comprising an electric solenoid for actuating said lock and release assembly to engage said actuator assembly to the manual mechanical linkage shaft, and a release spring for disengaging said actuator assembly from the manual mechanical linkage shaft.

14. The apparatus as recited in claim 13, further comprising a master cylinder joined to said actuator assembly, electric servomotor, lock and release assembly, and said electric solenoid for forming a unit suitable for replacing a manual hydraulic master cylinder of the manual brake system, thereby adding the apparatus to the manual brake system.

15. The apparatus as recited in claim 14, wherein said actuator assembly, electric servomotor, lock and release assembly, and said electric solenoid are centrally located about a linkage shaft joined to said master cylinder enabling said actuator assembly, electric servomotor, lock and release assembly, and said electric solenoid to be positioned in a plurality of positions for facilitating adding the apparatus to the manual brake system.

16. The apparatus as recited in claim 8, further comprising a hydraulic cylinder having a mechanical linkage suitable for engaging said lock and release assembly and said actuator assembly for enabling the apparatus to be added to a hydraulic line of the manual brake system.

17. A system comprising:
means for controlling a movement of a manual mechanical linkage shaft in a manual brake system for a vehicle wheel;
means for driving said controlling means wherein a manually applied force to the manual mechanical linkage shaft is modulated or pulsed;
means for engaging and disengaging said controlling means to and from the manual mechanical linkage shaft;
means for actuating said engaging and disengaging means; and
means for controlling said driving means during a braking of the vehicle wheel to mitigate skidding of the vehicle wheel during the braking.

18. The system as recited in claim 17, further comprising means for generating a signal comprising rotational information of the wheel.

19. The system as recited in claim 17, further comprising means for automatically activating or deactivating the system in response to changes in force or pressure.

20. The system as recited in claim 17, further comprising means for powering the system.

21. The system as recited in claim 17, further comprising means for engaging and disengaging the system, and for varying a frequency of said pulsed force.

22. A system comprising:
an actuator assembly configured for controlling a movement of a manual mechanical linkage shaft in a manual brake system for a vehicle wheel;
an electric motor for driving said actuator assembly wherein a manually applied force to the manual mechanical linkage shaft is modulated or pulsed;
a lock and release assembly configured for engaging and disengaging said actuator assembly to and from the manual mechanical linkage shaft;
means for actuating said lock and release assembly to engage said actuator assembly to the manual mechanical linkage shaft, and disengage said actuator assembly from the manual mechanical linkage shaft; and
an electronic controller for controlling said electric motor during a braking of the vehicle wheel to mitigate skidding of the vehicle wheel during the braking.

23. The system as recited in claim 22, further comprising a tone ring and a wheel speed sensor for generating a signal comprising rotational information of the wheel, said tone ring and said wheel speed sensor being configured for joining to an outside of the wheel's axel.

24. The system as recited in claim 23, wherein said tone ring comprises a gear shape on a circumference of a disc.

25. The system as recited in claim 22, wherein said electronic controller receives and uses GPS information to determine ground speed of the vehicle.

26. The system as recited in claim 25, wherein said electronic controller comprises a portable computing device.

27. The system as recited in claim 26, wherein said portable computing device provides a vehicle's operator with audio and/or visual signals during a skidding event.

28. The system as recited in claim 22, further comprising at least one switch for automatically activating or deactivating the system in response to changes in force or pressure.

29. The system as recited in claim 22, further comprising a portable battery supply for powering the system.

30. The system as recited in claim 22, further comprising an operator control for engaging and disengaging the system, and for varying a frequency of said pulsed force.
